(19) United States
(12) Patent Application Publication
(10) Pub. No.: US 2024/0292211 A1
(43) Pub. Date: Aug. 29, 2024

(54) METHODS FOR SETTING UP A SECURE CONNECTION BETWEEN A VEHICLE AND A USER TERMINAL AND ASSOCIATED DEVICES

(71) Applicant: IDEMIA FRANCE, Courbevoie (FR)

(72) Inventors: Bruno LETELLIER, Courbevoie (FR); Gianni UGLIETTI, Courbevoie (FR)

(73) Assignee: IDEMIA FRANCE, Courbevoie (FR)

(21) Appl. No.: 18/589,622

(22) Filed: Feb. 28, 2024

(30) Foreign Application Priority Data
Feb. 28, 2023 (FR) 23 01844

(51) Int. Cl. H04W 12/03; H04W 4/40; H04W 12/63

(52) U.S. Cl. CPC H04W 12/03; H04W 4/40; H04W 12/63

(57) ABSTRACT

The invention relates to a method for initializing a secure connection, comprising:
reception, by a control unit of a vehicle, of a first secret transmitted beforehand by a system to a device; and
set-up of a secure communication channel between the control unit of the vehicle and a user terminal, provided that the first secret and a second secret stored by the user terminal satisfy a predefined condition,

wherein the control unit of the vehicle receives the first secret from a device via a wireless communication requiring proximity between the device and the control unit, after the device has received the first secret from the system.

### FIELD OF THE INVENTION

The invention relates to set-up of a secure connection between two devices, in particular in the automotive field.

### PRIOR ART

Vehicle manufacturers are launching services known as phone-as-a-key or Paak services, in order to replace conventional keys with a terminal such as a mobile phone. The terminal may thus be used, for example, to unlock a door of a vehicle or to start the engine of the vehicle.

To perform these functions, the terminal communicates with a device of the vehicle, generally called the ECU, via a secure channel.

Before the secure channel is set up, it has been proposed to carry out a method comprising the following steps: a server generates a first secret and a second secret, the server transmits the first secret to the ECU, and the second secret to the terminal. The terminal and the ECU jointly verify whether the first secret and second secret are related by a predefined mathematical relationship. The secure channel is set up only if verification succeeds.

Since the ECU is located on board a vehicle, the ECU generally receives the first secret via a wireless radio-communication network. However, such a solution may prove difficult to implement in the case where the network coverage of the ECU is low, for example in a not spot, and/or when reception is degraded, for example in an underground parking lot.

### SUMMARY OF THE INVENTION

One aim of the invention is therefore to enable secure off-line connection between the telecommunication device and the vehicle when the control unit of the vehicle cannot receive the first secret from the server.

To this end, provision is made, according to the invention, for a method for initializing a secure connection, comprising:
reception, by a control unit of a vehicle, of a first secret transmitted beforehand by a system to a device; and
set-up of a secure communication channel between the control unit of the vehicle and a user terminal, provided that the first secret and a second secret stored by the user terminal satisfy a predefined condition,

wherein the control unit of the vehicle receives the first secret from the device via a wireless communication requiring proximity between the device and the control unit, after the device has received the first secret from the system.

Provision is also made for a method for initializing a secure connection, comprising:
reception, by a device, of a first secret transmitted beforehand by a system; and
transmission by the device of the first secret to a control unit of a vehicle via a wireless communication requiring proximity between the device and the control unit of the vehicle, the control unit of the vehicle being configured to set up a secure communication channel with a user terminal, provided that the first secret and a second secret stored by the user terminal satisfy a predefined condition.

Provision is further made for a method for initializing a secure connection, comprising:
transmission, by a system, of a first secret to a device, the device being configured to transmit the first secret to a control unit of a vehicle via a wireless communication requiring proximity between the device and the control unit of the vehicle; and
transmission by the system of a second secret to a user terminal, the user terminal being configured to set up a secure communication channel with the control unit of the vehicle, provided that the first secret and second secret satisfy a predefined condition.

In the invention, the device plays the role of relay in the communication between the server and the vehicle. This allows the control unit of the vehicle to receive the first secret even when the control unit is in an area that prevents direct radio communications between the server and the control unit, such as an underground parking lot. Specifically, the device, having received the first secret beforehand, is able to transmit this first secret to the control unit of the vehicle, given their mutual proximity.

Provision may be made for the second secret to be transmitted to the user terminal by the system provided that an identifier specific to the device transmitted by the control unit of the vehicle to the system and a reference identifier specific to the vehicle stored in a database of the system are identical to a first identifier and second identifier transmitted by the user terminal to the system, respectively, the first identifier and second identifier being transmitted beforehand by the device to the user terminal via a wireless communication requiring proximity between the user terminal and the device.

Provision may be made for the first secret to be a password checker configured to permit set-up of the secure communication channel between the control unit of the vehicle and the user terminal provided that a candidate password transmitted by the user terminal to the control unit of the vehicle matches the second secret.

Provision may be made for transmission of the first secret from the device to the control unit of the vehicle to comprise:
near-field communication (NFC), or
optical read-out, by the control unit of the vehicle, of a pattern representative of the first secret and displayed by the device, the pattern for example being a bar code or a QR code.

Provision may be made for the device to be a chip card.

According to the invention, provision is also made for a control unit for a vehicle, the control unit comprising:
a first communication interface configured to receive a first secret transmitted beforehand by a system to a device; and
a second communication interface configured to set up a secure communication channel between the control unit of the vehicle and a user terminal, provided that the first secret and a second secret stored by the user terminal satisfy a predefined condition, wherein the first communication interface is configured to receive the first secret from the device via a wireless communication requiring proximity between the device and the control unit, after the device has received the first secret from the system.

Provision is also made, according to the invention, for a device, such as a chip card, comprising:
a memory storing a first secret transmitted beforehand by a system; and
a communication interface configured to transmit the first secret to a control unit of a vehicle via a wireless communication requiring proximity between the device and the control unit of the vehicle, the control unit of the vehicle being configured to set up a secure communication channel with a user terminal, provided that the first secret and a second secret stored by the user terminal satisfy a predefined condition.

Provision may be made for the memory of the device to store a first identifier and a second identifier, and for the communication interface of the device to further be configured to:
transmit the first identifier to a control unit of a vehicle and receive the second identifier transmitted by the control unit of the vehicle, via a wireless communication requiring proximity between the device and the control unit of the vehicle;
transmit the first identifier and second identifier to a user terminal via a wireless communication requiring proximity between the device and the user terminal.

Provision may further be made for the first identifier to be able to be, for example, an identifier specific to the device and for the second identifier to be able to be, for example, an identifier specific to a vehicle.

Provision is further made for a system comprising:
a communication interface configured to transmit a first secret to a device, the device being configured to transmit the first secret to a control unit of a vehicle via a wireless communication requiring proximity between the device and the control unit of the vehicle; and
a second communication interface configured to transmit a second secret to a user terminal, the user terminal being configured to set up a secure communication channel with the control unit of the vehicle, provided that the first secret and second secret satisfy a predefined condition.

Provision may be made for the system to comprise a third communication interface configured to receive an identifier specific to the device transmitted by the control unit of the vehicle and an identifier specific to the vehicle transmitted by the control unit of the vehicle.

### DESCRIPTION OF THE FIGURES

One embodiment of the invention will now be described by way of non-limiting example with reference to the drawings, in which:

FIG. 1 schematically illustrates near-field communications between the control unit of the vehicle and the user terminal;

FIG. 2 illustrates a map of the exchanges between a system, a device and a control unit of the vehicle before a first start-up of the vehicle;

FIG. 3 shows a map of the exchanges between the system, the device, the control unit of the vehicle and the user terminal after the first start-up of the vehicle; and

FIG. 4 is a flowchart of one embodiment of the method according to the invention.

### DETAILED DESCRIPTION OF THE INVENTION

### Devices

With reference to FIG. 1, a vehicle 4 comprises an internal reader 6 and a control unit 3.

The internal reader 6 comprises:
a first communication interface 61 configured to receive data, for example via a near-field communication (for example an NFC or Bluetooth communication) with a user terminal 5 and/or a device 2; and
a second communication interface 62 configured to transmit data to the control unit 3 of the vehicle 4.

The first communication interface 61 may for example be located in the passenger compartment 63 of the vehicle, or indeed in the door 64, or both.

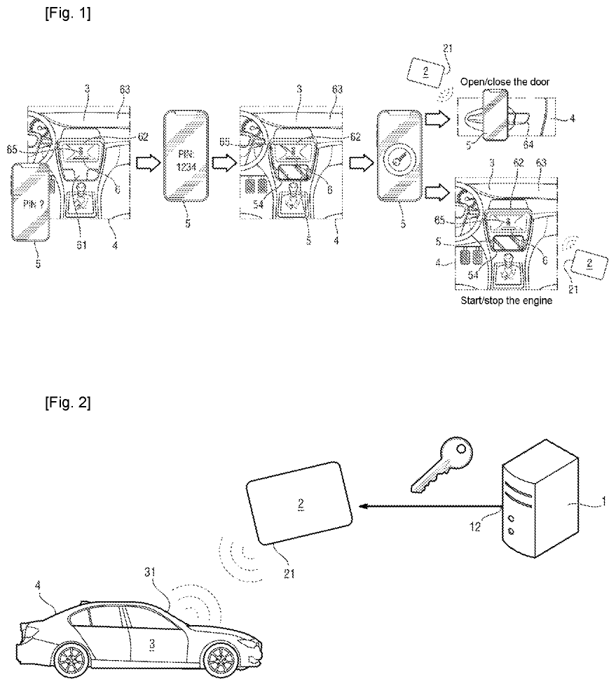

With reference to FIGS. 2 and 3, the control unit 3 comprises:
a first communication interface 31;
a second communication interface 32; and
a first memory (not shown in the figures).

The first and second interfaces 31, 32 are configured to act as poller and/or listener in a near-field communication (for example an NFC or Bluetooth communication) with a device 2 and a user terminal 5, respectively.

With regard to parameterizing and dimensioning the first communication interface 31 and second communication interface 32, those skilled in the art may refer to the following documents: NFC Analog Technical Specification 2.1—NFC Forum and NFC Digital Protocol Technical Specification 2.1; and to the document Digital Key Release 3, Technical Specification 1.1.0—Car Connectivity Consortium.

For example, when acting as listener, the first interface 31 is configured to receive from the device 2 a first secret and an identifier specific to the device 2. When acting as poller, the first interface 31 is configured to transmit to the device 2 an identifier specific to the vehicle 4. Furthermore, the second communication interface 32 is configured to set up a secure communication channel between the control unit 3 of the vehicle 4 and the user terminal 5. Set-up of the secure channel may for example follow a SPAKE2+ security protocol employing the first secret transmitted to the control unit 3 of the vehicle 4, for example a password checker configured to permit set-up of the secure channel between the terminal 5 and the control unit 3 of the vehicle 4 provided that a candidate password transmitted by the user terminal 5 to the control unit 3 of the vehicle 4 matches a second secret, for example a pairing password, transmitted beforehand to the user terminal 5 by a system 1.

With regard to parameterizing set-up of the secure communication channel, those skilled in the art may refer to the following documents: Network Working Group Internet Draft: SPAKE2+, an Augmented SPAKE, draft-bar-cfrg-spake2plus-00, Mar. 9, 2020, and Digital Key Release 3, Technical Specification 1.1.0-Car Connectivity Consortium.

The control unit 3 of the vehicle 4 may further comprise a third communication interface 33 configured to transmit the identifier specific to the vehicle 4 and the identifier specific to the device 2 to the system 1.

The memory of the control unit 3 of the vehicle 4 is configured to store data, the first secret for example. In particular, the memory of the control unit 3 of the vehicle 4 is configured to store the password checker transmitted by the device 2. In addition, the memory of the control unit 3 of the vehicle 4 is configured to store the identifier specific to the vehicle 4 and the identifier specific to the device 2.

The device 2 may be a chip card comprising at least:
a second memory (not shown in the figures); and
a communication interface 21.

The communication interface 21 of the device 2 comprises an NFC module and an antenna coil. The antenna coil has one or more coplanar coaxial windings parallel to the plane of the card, and therefore has a magnetic axis perpendicular to the plane of the card. The communication interface 21 of the device 2 is configured to carry out an NFC communication (contactless communication in the near field) with an external NFC terminal, for example the user terminal 5 (which for example is a smart phone), via the antenna coil. When the chip card (the device 2) and the external NFC terminal (user terminal 5) are placed sufficiently close to each other, the antenna coil of the card is inductively coupled to an antenna coil of the external NFC terminal (user terminal 5), and data may be exchanged using conventional NFC techniques such as those defined by the standards ISO 14443 and ISO 15693. To this end, the antenna coil of the chip card is associated with passive components (e.g. capacitors) to form an antenna circuit tuned to an operating frequency of the external NFC terminal (user terminal 5), for example 13.56 MHz.

In other embodiments, the communication interface 21 may comprise one of the following elements:
a Bluetooth module;
an electronic module configured to exchange data with the external NFC terminal, the user terminal 5 for example, when there is contact between the external terminal and the communication interface 21 according to the standard ISO7816-2:2017 of October 2017 or the standard ISO7810:2019 of December 2019;
a pattern, for example a bar code or a QR code (QR being the acronym of Quick Response), displayed by the device 2.

According to one embodiment, the communication interface 21 of the device 2 is configured to transmit the first secret to the control unit 3 of the vehicle 4 via an NFC communication. For example, the communication interface 21 of the device 2 is configured to transmit the password checker to the control unit 3 of the vehicle 4.

According to another embodiment, the communication interface 21 of the device 2 is configured to transmit the first secret, the password checker for example, via optical read-out, by the control unit 3 of the vehicle 4, of a pattern representative of the first secret and displayed by the device 2, the pattern for example being a bar code or a QR code.

The communication interface 21 of the device 2 is further configured to transmit a first identifier to the control unit 3 of the vehicle 4 and to receive a second identifier from the control unit 3 of the vehicle 4. The first identifier and second identifier are the identifier specific to the device 2 and the identifier specific to the vehicle 4, respectively.

In one embodiment, the communication interface 21 of the device 2 is configured to transmit the first identifier and second identifier to the user terminal 5 via a near-field communication. The first identifier is specific to the device 2 and the second identifier is specific to the vehicle 4.

According to another embodiment, the communication interface 21 of the device 2 is configured to transmit the first identifier and second identifier to the user terminal 5 via optical read-out, by the terminal 5, of a pattern representative of the first identifier and second identifier and displayed by the device 2, the pattern for example being a bar code or a QR code.

The memory of the device 2 is configured to store data, for example the first secret. In particular, the memory of the device 2 is configured to store the password checker transmitted by the communication interface 21 from the device 2 to the control unit 3 of the vehicle 4. In addition, the memory is configured to store the first identifier specific to the device 2 and the second identifier specific to the vehicle 4.

The user terminal 5 comprises at least:
a third memory (not shown);
a communication interface 51;
a communication interface 52; and
a communication interface 53.

The user terminal 5 may be a mobile terminal, for example a smart phone, or indeed a fixed terminal, a computer for example.

According to one embodiment, the communication interface 51 of the user terminal 5 is configured to receive the first identifier and second identifier transmitted by the device 2 via a near-field communication, for example an NFC or Bluetooth communication. The first identifier is specific to the device 2 and the second identifier is specific to the vehicle 4.

According to another embodiment, the communication interface 51 of the terminal 5 is configured to receive the first identifier and second identifier transmitted by the device 2 via optical read-out, by the user terminal 5, of a pattern representative of the first identifier and second identifier and displayed by the device 2, the pattern for example being a bar code or a QR code.

The second communication interface 52 of the user terminal 5 is configured to exchange data with the system 1. According to one embodiment, the communication interface 52 of the terminal 5 is configured to send the first identifier and second identifier to the system 1 via a radio communication, for example a GSM communication (GSM standing for Global System for Mobile), and to receive the second secret transmitted by the system 1 by radiocommunication.

The third communication interface 53 of the user terminal 5 is configured to exchange data with the control unit 3 of the vehicle 4, via a near-field communication, for example an NFC or Bluetooth communication. For example, the third communication interface 53 of the user terminal 5 is configured to transmit the second secret to the control unit of the vehicle 4.

The communication interfaces 51 and 53 are further configured to exchange data with the control unit 3 of the vehicle 4, and to transmit data to the internal reader 6.

The memory of the user terminal 5 is configured to store data, the second secret for example. In particular, the memory is configured to store the pairing password transmitted by the system 1. In addition, the memory of the user terminal 5 is configured to store the first identifier and second identifier.

The user terminal 5 may comprise a computer program product, for example a mobile-phone application, comprising code instructions that are executed by a processor of the user terminal 5 that is configured to control the communication interfaces 51, 52, 53 of the user terminal 5 and the third memory of the user terminal 5.

The first secret and second secret, for example the password checker and the pairing password respectively, are transmitted by the system 1, which comprises:
a database configured to initially store a reference identifier specific to the vehicle 4 and the first and second secrets associated with the reference identifier specific to the vehicle 4, then to store the identifier specific to the device 2 and to associate it with the reference identifier specific to the vehicle 4, when the identifier specific to the device 2 together with the identifier specific to the vehicle 4 are transmitted by the control unit 3 of the vehicle 4 and when the identifier specific to the vehicle 4 matches the reference identifier specific to the vehicle 4 stored in the database; and
a server comprising:
a communication interface 11 configured to transmit the first secret to the device 2; and
a second communication interface 12 configured to transmit the second secret to the user terminal 5 provided that there is a match, in the database, between the reference identifiers specific to the vehicle 4 and specific to the device 2 that are stored therein, and the identifiers specific to the vehicle 4 (second identifier) and specific to the device 2 (first identifier) transmitted by the terminal 5 to the system 1, respectively;
a third communication interface 13 configured to receive the identifier specific to the vehicle 4 and the identifier specific to the device 2 transmitted by the control unit 3 of the vehicle 4; and
a fourth communication interface 14 configured to receive the first identifier and second identifier transmitted by the user terminal 5.

The system 1 may further comprise a plurality of interconnected servers.

The second secret may be a pairing password able to be recognized by the password checker.

### Method

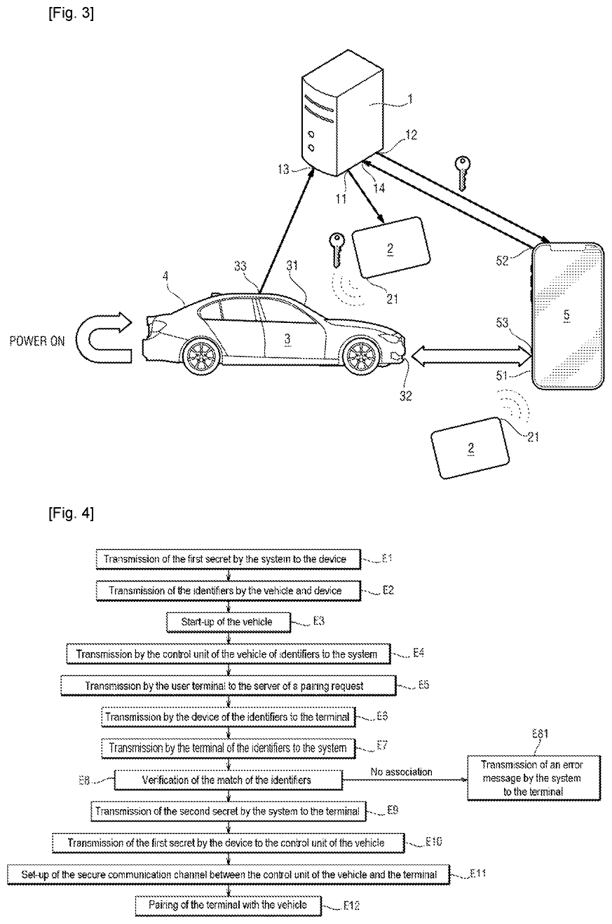

With reference to FIG. 4, a method implemented jointly by the system 1, the control unit 3 of the vehicle 4, the device 2 and the user terminal 5 comprises the following steps.

In a step E1, the system 1 transmits the first secret to the device 2.

In a step E2, the device 2 transmits the identifier specific to the device 2 to the control unit 3 of the vehicle 4 and the control unit 3 of the vehicle 4 transmits the identifier specific to the vehicle 4 to the device 2.

In a step E3, the vehicle 4 is started for the first time.

In a step E4, the system 1 receives the identifier specific to the device 2 and the identifier specific to the vehicle 4 transmitted by the control unit 3 of the vehicle 4 and verifies the existence of a match in the database between the received identifier specific to the vehicle 4 and the reference identifier specific to the vehicle 4 stored in the database. In the event of a match, the received identifier specific to the device 2 is stored in the database in order to associate it with the reference identifier specific to the vehicle 4.

In a step E5, a user of the vehicle 4 sends a request to the system 1 in order to initiate an attempt to pair the user terminal 5 with the vehicle 4, for example via the application of the manufacturer of the vehicle 4.

At this stage, the user terminal 5 asks the user to place the device 2 close to the user terminal 5, for example by notifying her or him via the application by means of a message.

In a step E6, the device 2 transmits the identifier specific to the device 2 and the identifier specific to the vehicle 4 to the user terminal 5 via a wireless communication requiring proximity between the device 2 and the user terminal 5, for example via a near-field communication (NFC), or optical read-out by the user terminal 5 of a pattern representative of the identifiers and displayed by the device 2, the pattern for example being a bar code or a QR code.

In a step E7, the user terminal 5 transmits the identifier specific to the device 2 and the identifier specific to the vehicle 4 to the system 1.

In a step E8, the system 1 verifies the existence of a match, in the database, between the reference identifiers specific to the vehicle 4 and specific to the device 2 that are stored therein, and the identifiers specific to the vehicle 4 and specific to the device 2 transmitted by the terminal 5 to the system 1 in step E7, respectively.

When there is a match, the system transmits, in a step E9, the second secret associated with the pair of identifiers stored in the database to the user terminal 5.

Next, in a step E10, the device 2 transmits the first secret to the control unit 3 of the vehicle 4 via a wireless communication requiring proximity between the device 2 and the control unit 3, for example via a near-field communication (NFC), or via optical read-out by the control unit 3 of the vehicle 4 of a pattern representative of the first secret and displayed by the device 2, the pattern for example being a bar code or a QR code.

Provision may be made for the device 2 to transmit the first secret to the control unit 3 of the vehicle 4 earlier, for example after start-up of the vehicle (step E3).

The first secret may for example be the password checker and the second secret the pairing password. In the present case, the user terminal 5 transmits a candidate password to the control unit 3 of the vehicle 4 via a near-field communication (for example a Bluetooth or NFC communication), the password checker thus permitting set-up of the secure communication channel between the terminal 5 and the control unit 3 of the vehicle 4 provided that the candidate password transmitted by the user terminal 5 to the control unit 3 of the vehicle 4 matches the pairing password transmitted by the system 1 to the user terminal 5.

If the password checker gives its permission, the secure communication channel between the control unit 3 of the vehicle 4 and the user terminal 5 is set up in a step E11.

In a step E12, the user is invited, for example through receipt of a notification on her or his terminal 5, to pair her or his terminal 5 with the vehicle 4. For example, she or he may place her or his terminal 5 in proximity to the internal reader 6 of the vehicle 4 in order to proceed with the pairing. By pairing, what is meant is a procedure for generating, sharing and storing cryptographic keys between the control unit 3 of the vehicle 4 and the user terminal 5, via the secure communication channel, in order to allow the user terminal 5 to interact with the vehicle 4 (for example to allow the user terminal 5 to control various components of a vehicle, and for example to open the doors or start the engine).

The user terminal 5 is paired with the vehicle 4.

The user may then interact with the various components of the vehicle 4 via near-field communication. For example, she or he may place her or his user terminal 5 or her or his device 2 close to the handle in order to unlock the doors of the vehicle 4 then, when she or he has gotten into the passenger compartment, she or he may place her or his terminal 5 in the internal reader 6 of the vehicle 4 in order to start the engine.

In the case where there is no match, the system 1 transmits, in a step E81, to the user terminal 5 an error message instead of the second secret, the error message indicating that the user terminal 5 is not permitted to communicate with the vehicle 4, or to initiate set-up of a secure channel.

1. A method for initializing a secure connection, comprising:
reception, by a control unit of a vehicle, of a first secret transmitted beforehand by a system to a device; and
set-up of a secure communication channel between the control unit of the vehicle and a user terminal, provided that the first secret and a second secret stored by the user terminal satisfy a predefined condition,
wherein the control unit of the vehicle receives the first secret from the device via a wireless communication requiring proximity between the device and the control unit, after the device has received the first secret from the system.

2. A method for initializing a secure connection, comprising:
reception, by a device, of a first secret transmitted beforehand by a system; and
transmission by the device of the first secret to a control unit of a vehicle via a wireless communication requiring proximity between the device and the control unit of the vehicle, the control unit of the vehicle being configured to set up a secure communication channel with a user terminal, provided that the first secret and a second secret stored by the user terminal satisfy a predefined condition.

3. A method for initializing a secure connection, comprising:
transmission, by a system, of a first secret to a device, the device being configured to transmit the first secret to a control unit of a vehicle via a wireless communication requiring proximity between the device and the control unit of the vehicle; and
transmission by the system of a second secret to a user terminal, the user terminal being configured to set up a secure communication channel with the control unit of the vehicle, provided that the first secret and second secret satisfy a predefined condition.

4. The method as claimed in claim 1, wherein the second secret is transmitted to the user terminal by the system provided that an identifier specific to the device transmitted by the control unit of the vehicle to the system and a reference identifier specific to the vehicle stored in a database of the system are identical to a first identifier and second identifier transmitted by the user terminal to the system, respectively,
the first identifier and second identifier being transmitted beforehand by the device to the user terminal via a wireless communication requiring proximity between the user terminal and the device.

5. The method as claimed in claim 1, wherein the first secret is a password checker configured to permit set-up of the secure communication channel between the control unit of the vehicle and the user terminal provided that a candidate password transmitted by the user terminal to the control unit of the vehicle matches the second secret.

6. The method as claimed in claim 1, wherein transmission of the first secret from the device to the control unit of the vehicle comprises:
near-field communication, or
optical read-out, by the control unit of the vehicle, of a pattern representative of the first secret and displayed by the device, the pattern for example being a bar code or a QR code.

7. The method as claimed in claim 1, wherein the device is a chip card.

8. A control unit for a vehicle, the control unit comprising:
a first communication interface configured to receive a first secret transmitted beforehand by a system to a device; and
a second communication interface configured to set up a secure communication channel between the control unit of the vehicle and a user terminal, provided that the first secret and a second secret stored by the user terminal satisfy a predefined condition,
wherein the first communication interface is configured to receive the first secret from the device via a wireless communication requiring proximity between the device and the control unit, after the device has received the first secret from the system.

9. A device, such as a chip card, comprising:
a memory storing a first secret transmitted beforehand by a system; and
a communication interface configured to transmit the first secret to a control unit of a vehicle via a wireless communication requiring proximity between the device and the control unit, the control unit of the vehicle being configured to set up a secure communication channel with a user terminal, provided that the first secret and a second secret stored by the user terminal satisfy a predefined condition.

10. A system comprising:
a communication interface configured to transmit a first secret to a device, the device being configured to transmit the first secret to a control unit of a vehicle via a wireless communication requiring proximity between the device and the control unit of the vehicle; and
a second communication interface configured to transmit a second secret to a user terminal, the user terminal being configured to set up a secure communication channel with the control unit of the vehicle, provided that the first secret and second secret satisfy a predefined condition.
